(19) United States
(12) Patent Application Publication
(10) Pub. No.: US 2006/0202158 A1
(43) Pub. Date: Sep. 14, 2006

(54) Pigmented organic peroxides having disappearing red color

(76) Inventors: Chii-Shu Chen, East Hanover, NJ (US); Terry N. Myers, Phoenixville, PA (US)

Correspondence Address: Steven D. Boyd;Arkema Inc., 2000 Market Street, Philadelphia, PA, 19103, US

(21) Appl. No.: 11/078,160

(22) Filed: Mar. 11, 2005

(51) Int. Cl. C11D 3/39

(52) U.S. Cl. 252/186.1; 524/83

(57) ABSTRACT

The present invention relates to organic peroxide formulations that contain a reactive, compatible dye or pigment and their use in systems involving free radical reactions such as monomer polymerizations, resin and elastomer curing and polymer modifications. The dye or pigment appears red in the organic peroxide composition and during mixing of the organic peroxide with monomers, polymers and other systems to which organic peroxides are typically added before their use to generate free radicals. Once conditions are applied to decompose the peroxide into free radicals, the desired curing, crosslinking or polymerization reaction occurs and the red color disappears. The red color does not persist in the product at the end of the reaction and therefore does not adversely affect the desired final color of the reaction product.

### FIELD OF THE INVENTION

The present invention relates to pigmented organic peroxides. More particularly, the present invention relates to novel organic peroxide formulations containing a pigment or dye which provides a color that disappears when the organic peroxide decomposes into free radicals.

### BACKGROUND OF THE INVENTION

There currently exist, peroxide formulations that contain red or blue dye. Organic peroxides with permanent red dye have been used for years, predominantly in the area of unsaturated polyester and vinyl ester curing. The presence of the dye confirmed dispersion of the organic peroxides in the reactant mixtures. The red color, however, stayed with the final products, which was often considered undesirable by end-use customers for aesthetic reasons. A typical example is spraying of resin mix containing unsaturated polyester resin (UPR), calcium carbonate, chopped fiberglass, and red methyl ethyl ketone peroxide (MEKP) formulations through a chopper gun for the production of fiberglass reinforced polyester bath ware. The homogeneous red color indicates that the red MEKP is mixed and sprayed to its optimal conditions. However, once the resin cures, the bath ware retains a pink to red color depending on how much permanent red dye is used.

Peroxide formulations that contain red or blue dye that disappears when the peroxide is used in an end-use application are known in the art. For example, JP 59-120612 (1984) discloses a dyed organic peroxide composition, which had good storage stability. The degree of mixture could be verified by color when the dyed peroxide was mixed into unsaturated polyester resin or vinyl ester resin. The red dye provided color that disappeared as the resin gelled and hardened and did not spoil the appearance of the product. Kayaset Red R-902, Kayaset Red R-910, Kayaset Red R-922, Kayaset Rubin 712, and Kayaset Scarlet 926 were disclosed as dyes that could be use successfully.

There are, however, problems associated with current products, such as incomplete color disappearance upon use, poor solubility of the dye in the peroxide formulation, poor thermal and color stability of the dyed peroxide formulations, and insufficient initial color in the commercial formulations. Thus, there exists a need for improved formulations with dyes that perform better.

### SUMMARY OF THE INVENTION

The present invention relates to organic peroxide formulations that contain a reactive, compatible dye or pigment and their use in systems involving free radical reactions such as monomer polymerizations, resin and elastomer curing and polymer modifications. As used herein, the terms dye and pigment are interchangeable. The dye or pigment appears red in the organic peroxide composition and during mixing of the organic peroxide with monomers, polymers and other systems to which organic peroxides are typically added before their use to generate free radicals. The red dye aids in verifying that the organic peroxide has been added and is homogeneously dispersed in the system. Once conditions are applied to decompose the peroxide into free radicals, the red color disappears. This provides visual indication that the free radical reaction is occurring or has occurred. The red color does not persist in the product at the end of the reaction and therefore does not interfere with the desired color of the final reaction product.

### DETAILED DESCRIPTION

In the present invention, a dye, C.I. Disperse Red 177 (1), CAS Registry Number 68133-69-7, has been discovered to be an effective disappearing red dye for organic peroxide products. The dye has the formula:

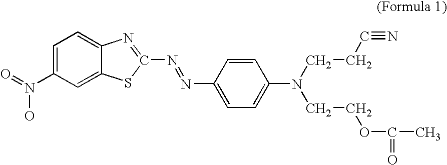

The dye, referred to herein as the dye of formula 1 or (1), is a solid, but can easily be mixed with organic solvents (such as N-methylpyrrolidone) to form dye solutions.

The so formed dye solutions can be mixed with peroxides such as ketone peroxides, hydroperoxides, diacyl peroxides, dialkyl peroxides, diperoxyketals, peroxydicarbonates, peroxyesters and mixtures thereof to provide red organic peroxide formulations that can be handled, shipped and stored safely and can be used to complete free radical reactions in which the red color disappears.

Examples of organic peroxides that can be safely mixed with the dye of formula 1 include:

ketone peroxide formulations such as methyl ethyl ketone peroxide (MEKP), methyl isobutyl ketone peroxide, 2,4-pentanedione peroxide, benzoyl peroxide and cyclohexanone peroxide, dilutions, mixtures and blends thereof;

hydroperoxides such as cumene hydroperoxide (CHP), t-butyl hydroperoxide, t-amyl hydroperoxide, 1,1,3,3-tetramethylbutyl hydroperoxide, 1,1-dimethyl-3-hydroxybutyl hydroperoxide, 2,5-dimethyl-2,5-hexanedihydroperoxide, 1,3- and 1,4-phenylenebis(1-methylethylidene)bishydroperoxides, dilutions, solutions, mixtures and blends thereof;

diacyl peroxides such as dibenzoyl peroxide, dilauroyl peroxide, didecanoyl peroxide, diisononanoyl peroxide, di(2,4-dichlorobenzoyl) peroxide, dimyristyl peroxide, dilutions, solutions, mixtures and blends thereof;

dialkyl peroxides such as di(t-butyl) peroxide, di(t-amyl) peroxide, dicumyl peroxide, 1,3- and 1,4-bis(1-(t-butylperoxy)-1-methylethyl)benzene, t-butyl cumyl peroxide, 1-butyl 1,1,3,3-tetramethylbutyl peroxide, t-butyl 1-methoxycyclohexyl peroxide, t-amyl 1-ethoxycyclohexyl peroxide, 2,5-di(t-butylperoxy)-2,5-dimethylhexane, dilutions, solutions, mixtures and blends thereof;

diperoxyketals such as 1,1-di(t-butylperoxy)cyclohexane, 1,1-di(t-amylperoxy)cyclohexane, 1,1-di(t-butylperoxy)-3,3,5-trimethylcyclohexane, ethyl 3,3-di(t-butylperoxy)butanoate, n-butyl 4,4-di(t-butylperoxy)valerate, ethyl 3,3-di(t-amylperoxy)butanoate, n-butyl 4,4-di(t-amylperoxy)valerate, dilutions, solutions, mixtures and blends thereof;

peroxydicarbonates such as di(2-ethylhexyl) peroxydicarbonate, di(sec-butyl) peroxydicarbonate, dicyclohexyl peroxydicarbonate, di(4-t-butylcyclohexyl) peroxydicarbonate, di(n-propyl) peroxydicarbonate, di(n-butyl) peroxydicarbonate, dicetyl peroxydicarbonate, dimyristyl peroxydicarbonate, dilutions, solutions, mixtures and blends thereof; and

peroxyesters such as 3-hydroxy-1,1-dimethylbutyl peroxyneodecanoate, α-cumyl peroxyneodecanoate, t-butyl peroxyneodecanoate, t-amyl peroxyneodecanoate, 1,1,3,3-tetramethylbutyl peroxyneodecanoate, t-butyl peroxypivalate, t-amyl peroxypivalate, 1,1,3,3-tetramethylbutyl peroxypivalate, t-butyl peroxy-2-ethylhexanoate, t-amyl peroxy-2-ethylhexanoate, t-amyl peroxyacetate, t-butyl peroxyacetate, t-butyl peroxybenzoate, t-amyl peroxybenzoate, 2,5-di(2-ethylhexanoylperoxy)-2,5-dimethylhexane, OO-(t-amyl) O-(2-ethylhexyl) monoperoxycarbonate, OO-(t-butyl) O-(2-ethylhexyl) monoperoxycarbonate, OO-(t-butyl) O-isopropyl monoperoxycarbonate, polyether poly-t-butylperoxy carbonate, t-butyl peroxy-3,5,5-trimethylhexanoate, t-amyl peroxy-3,5,5-trimethylhexanoate, dilutions, solutions, mixtures and blends thereof.

The dyed peroxide formulations can also be other extended formulations such as diacyl peroxide or dialkyl peroxide pastes and dispersions prepared by means well known in the art. For example, benzoyl peroxide is widely distributed in paste formulations that are well suited for use with the dye. Blended solutions of peroxides such as those prepared from ketone peroxides and hydroperoxides, like MEKP and CHP blends, can be dyed with the dye of formula 1. Blended solutions of peroxyesters and diperoxyketals are also sold commercially and suitable for use with (1), such as mixtures of t-butyl peroxy-2-ethylhexanoate and 1,1-di(t-butylperoxy)cyclohexane in mineral spirits or other safety diluents.

Examples of applications that can use the dyed organic peroxide formulations include the following.

Unsaturated polyester resins, vinyl ester resins, vinyl monomer such as styrene, and curable rubbers and curable elastomers can be cured or polymerized with peroxide formulations containing the dye of formula 1.

In a typical unsaturated polyester resin or vinyl ester resin curing application, MEKP products, CHP, MEKP/CHP blends, 2,4-pentanedione peroxide, benzoyl peroxide paste, diperoxyketals, peroxydicarbonates and peroxyesters are used. The resin containing dyed peroxide(s) shows red color during and after mixing with the resins and other fillers like calcium carbonate and chopped fiberglass. During a subsequent cure period in which free radicals are generated either thermally or by promoted decomposition of the peroxide with a transition metal promoter or amine or their combinations, the red color disappears. The mixing and/or application procedures can be spray up, resin transfer molding, compression molding of sheet molding compound (SMC) and bulk molding compound (BMC), pultrusion or cure-in-place-pipe operations. The end products are known as the fiberglass-reinforced polyester or vinyl ester composites or cast products.

Free radical modification of polymers such as crosslinking of polyolefins or curing of elastomers can be done with peroxide formulations containing the dye of formula 1. The dyed peroxide formulation(s) is mixed with the polymer prior to reaction, and the even red color provided by the dye of formula 1 indicates that the peroxide is homogeneously dispersed in the polymer matrix. The mixture is heated to decompose the peroxide and crosslink or cure the polymer(s) with the disappearance of the red color. The mixing of the peroxide with the polymer and the subsequent crosslinking or curing reaction can be accomplished by any means known in the art.

Free radical vinyl monomer polymerization can be done with peroxide formulations containing the dye of formula 1. In this instance, the presence of the dye of formula 1 indicates that the peroxide formulation is present and satisfactorily dispersed in the reaction mixture before the reaction takes place. During the free radical reaction to polymerize or copolymerize the monomer or monomers, the red color disappears. Again, any art process for polymerizing vinyl monomers with organic peroxides can be done in the presence of the dye of formula 1.

### EXAMPLES

The following non-limiting examples evidence the efficacy of the dye of formula 1 as a disappearing dye for peroxide formulations. In the examples, the red color intensity (a* component of the L*a*b* color space) of the samples and controls was measured using a HunterLab ColorQuest™ Colorimeter. For a liquid sample, measurement was made on a small quantity of the initial, intermediate and final experimental solutions using a clear glass cuvette. For solid samples, measurement was made directly on the sample without a cuvette. For systems in which the change in color was monitored over time, the cuvette served as the reactor. The reactants were placed in the cuvette and the color measured. Subsequent time at room temperature (for promoted systems) or heating periods (for thermal systems) caused the intended reaction and color change. The reaction conditions prior to measurement of the sample and their corresponding a* were recorded and reported.

Gas evolution with time was measured indirectly from the distortion of a polyethylene bottle containing the sample being tested before and after exposure to the time and temperature conditions cited. All measurements were made with the samples at room temperature. The bottle was marked with graduated lines every ⅛ inch so that the comparative liquid level in the bottle was measurable. The bottle was filled to the lowest line and squeezed until the liquid level aligned with the highest line. Gas evolution lowered the liquid level, passing numbered gradation marks that indicated the relative amount of gassing observed. The distance between the initial liquid level and the level after exposure, reported as the number of ⅛-inch increments, comprised the gas rating. If the distance was zero (no gassing), then the gas rating was 0, if it was lower by ⅛ inch, then the gas rating was 1 and so forth. A higher gas rating indicated a peroxide formulation that produced gas and was therefore comparatively less stable.

The following reactants were used:

REACTANTS

| | |
|---|---|
| POLYLITE ® 33303-24 | Commercial medium reactivity low-viscosity pre- |
| | promoted orthophthalic unsaturated polyester resin |
| | from Reichhold, Inc. |
| POLYLITE ® 33306-00 | Commercial low-HAP, low viscosity, pre-promoted, |
| | thixotropic acrylic bonding resin from Reichhold, Inc. |
| Pultru ® P920-300 | Commercial resin specifically developed to meet the |
| | needs of the pultrusion industry (e.g., reduced styrene |
| | emissions) from AOC L.L.C. |
| S903 | Commercial unpromoted, high reactivity |
| | dicyclopentadiene (DCPD) polyester resin designed for |
| | a variety of closed mold applications, from AOC L.L.C. |
| Derakane Momentum ™ 411- | Commercial bisphenol-A epoxy vinyl ester resin from |
| 350 | Ashland, Inc. |
| Aropol ™ MR 12018 | Commercial unsaturated isophthalic polyester resin |
| | formulated especially for the requirements of cured-in- |
| | place pipe applications from Ashland Inc. |
| Cobalt Nap-All ™ | Commercial cobalt naphthenate, 6% in whatever |
| | solvent they use, from OM Group, Inc. |
| Ashland Low Profile Additive | Commercial poly(vinyl acetate), 40% in styrene, from |
| LP4016 | Ashland, Inc. |
| Acrylic Polymer 7301-IAXP | Commercial poly(methyl methacrylate), from Arkema |
| | Inc. |
| GE Silicones TR55 | Commercial methyl vinyl silicone rubber from GE |
| | Silicones |
| Luperox ® Delta-X9 | Commercial methyl ethyl ketone peroxide (MEKP) |
| | formulation from Arkema Inc. |
| Luperox ® DDM-30 | Commercial MEKP formulation from Arkema Inc. |
| Luperox ® DDM-9 | Commercial MEKP formulation from Arkema Inc. |
| Luperox ® DHD-9 | Commercial MEKP formulation from Arkema Inc. |
| Luperox ® CU90 | Commercial cumene hydroperoxide formulation from |
| | Arkema Inc. |
| Luperox ® KC70 | Commercial MEKP-cumene hydroperoxide formulation |
| | from Arkema Inc. |
| Catalyst 730 | Commercial MEKP-cumene hydroperoxide formulation |
| | from Arkema Inc. |
| Catalyst 11 | Commercial MEKP-cumene hydroperoxide formulation |
| | from Arkema Inc. |
| Luperox ® 224 | Commercial 2,4-pentanedione peroxide formulation |
| | from Arkema Inc. |
| Luperox ® ATC50 | Commercial benzoyl peroxide paste from Arkema Inc. |
| Luperox ® P | Commercial t-butyl peroxybenzoate from Arkema Inc. |
| Luperox ® TAP | Commercial t-amyl peroxybenzoate from Arkema Inc. |
| Luperox ® TBEC | Commercial OO-(t-butyl) O-(2-ethylhexyl) |
| | monoperoxycarbonate from Arkema Inc. |
| Luperox ® TBIC-M75 | Commercial OO-(t-butyl) O-isopropyl |
| | monoperoxycarbonate dilution in mineral spirits from |
| | Arkema Inc. |
| Luperox ® MC | Commercial proprietary formulation of OO-(t-amyl) O- |
| | (2-ethylhexyl) monoperoxycarbonate from Arkema Inc. |
| Luperox ® 7M75 | Commercial t-butyl peroxyacetate dilution in mineral |
| | spirits from Arkema Inc. |
| Luperox ® 555M60 | Commercial t-amyl peroxyacetate dilution in mineral |
| | spirits from Arkema Inc. |
| Luperox ® 231 | Commercial 1,1-di(t-butylperoxy)-3,3,5- |
| | trimethylcyclohexane from Arkema Inc. |
| Luperox ® 26 | Commercial t-butyl peroxy-2-ethylhexanoate from |
| | Arkema Inc. |
| Luperox ® 575 | Commercial t-amyl peroxy-2-ethylhexanoate from |
| | Arkema Inc. |
| Luperox ® 256 | Commercial 2,5-di(2-ethylhexanoylperoxy)-2,5- |
| | dimethylhexane from Arkema Inc. |
| Luperox ® M33 | Commercial dilution of t-butyl peroxy-2-ethylhexanoate |
| | and 1,1-di(t-butylperoxy)cyclohexane from Arkema Inc. |
| Luperox ® 223V75 | Commercial di(2-ethylhexyl) peroxydicarbonate in |
| | proprietary diluent from Arkema Inc. |
| Luperox ® 101 | Commercial 2,5-di(t-butylperoxy)-2,5-dimethylhexane |
| | from Arkema Inc. |

### Example 1

### Organic Peroxide Formulations Containing the Dye of Formula 1

The following dyed organic peroxide formulations were prepared by mixing the components shown in Table 1. Mixing was accomplished by magnetic stirring or simply by hand. A homogeneous red mixture was obtained as the product. The dye solutions shown in the Table were prepared similarly, by simply mixing the dye in the solvent shown until a homogeneous solution was obtained. The designations shown are used throughout the other examples.

TABLE 1
Organic Peroxide Formulations Containing the dye of formula 1

| | | | | | % Other Component(s) | Dyed |
|---|---|---|---|---|---|---|
| | Peroxide | % In | | % In | in | Peroxide |
| Peroxide | Source | Formulation | Dye source | Formulation | Formulation | Designation |
| MEKP | Luperox | 99.65 | 20% (1) in | 0.35 | — | Delta-X9- |
| | Delta-X9 | | NMP | | | DR(0.35) |
| MEKP | Luperox | 99.63 | 20% (1) in | 0.38 | — | Delta-X9- |
| | Delta-X9 | | NMP | | | DR(0.38) |
| MEKP | Luperox | 99.59 | 20% (1) in | 0.41 | — | Delta-X9- |
| | Delta-X9 | | NMP | | | DR(0.41) |
| MEKP | Luperox | 99.40 | 11.75% (1) in | 0.60 | — | Delta-X9- |
| | Delta-X9 | | NMP | | | DR(0.60) |
| MEKP | Luperox | 99.82 | 15% (1) in | 0.16 | — | DDM-9- |
| | DDM-9 | | NMP | | | DR(0.16) |
| MEKP | Luperox | 99.76 | 15% (1) in | 0.24 | — | DDM-9- |
| | DDM-9 | | NMP | | | DR(0.24) |
| MEKP | Luperox | 99.06 | 15% (1) in | 0.94 | — | DDM-9- |
| | DDM-9 | | NMP | | | DR(0.94) |
| MEKP | Luperox | 98.59 | 15% (1) in | 1.41 | — | DDM-9- |
| | DDM-9 | | NMP | | | DR(1.41) |
| MEKP | Luperox | 99.40 | 11.75% (1) in | 0.60 | — | DDM-30-DR |
| | DDM-30 | | NMP | | | |
| MEKP | Luperox | 99.40 | 11.75% (1) in | 0.60 | — | DDM-9- |
| | DDM-9 | | NMP | | | DR(0.60) |
| MEKP | Luperox | 99.40 | 11.75% (1) in | 0.60 | — | DHD-9-DR |
| | DHD-9 | | NMP | | | |
| CHP | Luperox | 99.53 | 15% (1) in | 0.47 | — | CU90-DR |
| | CU90 | | NMP | | | |
| MEKP/CHP | Luperox | 99.40 | 11.75% (1) in | 0.60 | — | KC70-DR |
| Blend | KC70 | | NMP | | | |
| MEKP/CHP | Catalyst | 99.40 | 11.75% (1) in | 0.60 | — | Cat730-DR |
| Blend | 730 | | NMP | | | |
| MEKP/CHP | Catalyst | 99.40 | 11.75% (1) in | 0.60 | — | Cat11-DR |
| Blend | 11 | | NMP | | | |
| 2,4- | Luperox | 99.40 | 11.75% (1) in | 0.60 | — | 224-DR |
| pentanedione | 224 | | NMP | | | |
| peroxide | | | | | | |
| benzoyl | Luperox | 99.53 | 15% (1) in | 0.47 | — | ATC50-DR |
| peroxide, | ATC50 | | NMP | | | |
| 50% paste | | | | | | |
| with tricresyl | | | | | | |
| phosphate | | | | | | |
| t-butyl peroxybenzoate | Luperox P | 99.53 | 15% (1) in | 0.47 | — | P-DR |
| | | | NMP | | | |
| t-amyl peroxybenzoate | Luperox | 99.53 | 15% (1) in | 0.47 | — | TAP-DR |
| | TAP | | NMP | | | |
| OO-(t-butyl) | Luperox | 99.53 | 15% (1) in | 0.47 | — | TBEC-DR |
| O-(2- | TBEC | | NMP | | | |
| ethylhexyl) | | | | | | |
| monoperoxycarbonate | | | | | | |
| OO-(t-butyl) | Luperox | 99.53 | 15% (1) in | 0.47 | — | TBIC-M75-DR |
| O-isopropyl | TBIC- | | NMP | | | |
| monoperoxycarbonate, | M75 | | | | | |
| 75% in OMS | | | | | | |
| OO-(t-amyl) | Luperox | 99.53 | 15% (1) in | 0.47 | — | MC-DR |
| O-(2- | MC | | NMP | | | |
| ethylhexyl) | | | | | | |
| monoperoxycarbonate | | | | | | |
| t-butyl peroxyacetate, | Luperox | 99.53 | 15% (1) in | 0.47 | — | 7M75-DR |
| 75% in OMS | 7M75 | | NMP | | | |
| t-amyl peroxyacetate, | Luperox | 99.53 | 15% (1) in | 0.47 | — | 555M60-DR |
| 60% in OMS | 555M60 | | NMP | | | |
| 1,1-di (t- | Luperox | 69.73 | 15% (1) in | 0.33 | 29.93% NMP | 231N70-DR |
| butylperoxy)- | 231 | | NMP | | | |
| 3,3,5-trimethylcyclohexane | | | | | | |
| 1,1-di (t- | Luperox | 69.67 | 15% (1) in | 0.47 | 29.86% 2- | 231T70-DR |
| butylperoxy)- | 231 | | NMP | | butoxyethanol | |
| 3,3,5-trimethylcyclohexane | | | | | | |
| t-butyl | Luperox | 99.53 | 15% (1) in | 0.47 | — | 26-DR |
| peroxy-2- | 26 | | NMP | | | |
| ethylhexanoate | | | | | | |
| t-amyl | Luperox | 99.53 | 15% (1) in | 0.47 | — | 575-DR |
| peroxy-2- | 575 | | NMP | | | |
| ethylhexanoate | | | | | | |
| 2,5-di(2- | Luperox | 99.53 | 15% (1) in | 0.47 | — | 256-DR |
| ethylhexanoylperoxy)- | 256 | | NMP | | | |
| 2,5- | | | | | | |
| dimethylhexane | | | | | | |
| Blend of t- | Luperox | 99.53 | 15% (1) in | 0.47 | — | M33-DR |
| butyl peroxy- | M33 | | NMP | | | |
| 2-ethylhexanoate | | | | | | |
| and 1,1-di(t- | | | | | | |
| butylperoxy)- | | | | | | |
| cyclohexane | | | | | | |
| Di(2- | Luperox | 99.53 | 15% (1) in | 0.47 | — | 223V75-DR |
| ethylhexyl) | 223V75 | | NMP | | | |
| peroxydicarbonate, | | | | | | |
| 75 in | | | | | | |
| proprietary | | | | | | |
| diluent | | | | | | |
| 2,5-di(t-butylperoxy)- | Luperox | 77.76 | 15% (1) in | 0.37 | 21.87% NMP | 101N78-DR |
| 2,5- | 101 | | NMP | | | |
| dimethylhexane | | | | | | |
| 2,5-di(t-butylperoxy)- | Luperox | 38.88 | 15% (1) in | 0.18 | 10.94% NMP | 101N78S-DR |
| 2,5- | 101 | | NMP | | 50.0% silica | |
| dimethylhexane | | | | | powder | |

### Examples 2-5

### Use of MEKP Containing (1) to Cure Filled, Unsaturated Polyester Resin

Unsaturated polyester resin compositions were prepared by mixing 45 wt-% of saturated polyester resin (POLYLITE 33303-24), 55 wt-% of calcium carbonate and 1 phr of various dyed organic peroxide formulations shown in Table 2. The mixtures were cured at room temperature due to the presence of metal promoter formulated into the resin by the manufacturer, and the disappearance of the initiator red color was demonstrated by color measurement as described above. The color variation with time is shown in Table 2.

TABLE 2
Change in Red Color (as a*) Before and After Cure using MEKP
Formulations Containing the Dye of Formula 1

| | Red Color (as a*) | | | |
|---|---|---|---|---|
| | | | | Example 5 |
| | Example 2 | Example 3 | Example 4 | Commercial |
| Time | Initiator: Delta- | Initiator: Delta- | Initiator: Delta- | Competitive |
| (min) | X9-DR(0.35) | X9-DR(0.38) | X9-DR(0.41) | Control |
| 2 | 7.57 | 7.76 | 7.64 | — |
| 3 | 7.05 | 7.21 | 7.37 | 6.93 |
| 5 | 5.09 | — | 4.96 | 6.07 |
| 6 | 3.99 | 3.86 | 3.84 | — |
| 9 | 1.87 | — | 1.67 | — |
| 10 | 1.42 | 1.32 | 1.22 | — |
| 12 | — | — | — | 1.75 |
| 15 | 0.44 | 0.39 | 0.39 | — |
| 16 | — | — | — | 0.89 |
| 20 | 0.19 | 0.22 | 0.08 | 0.72 |
| 25 | 0.18 | 0.21 | −0.15 | 0.61 |
| 30 | 0.11 | 0.14 | −0.13 | 0.75 |

In these examples, MEKP containing the dye of formula 1 showed an initial dark red color that disappeared during the subsequent curing reaction. When compared to a commercial control, it appeared darker red before cure and less red after cure.

### Examples 6-9

### Use of Aged MEKP Containing the Dye of Formula 1 to Cure Unsaturated Polyester Resin

Delta-X9-DR(0.35), Delta-X9-DR(0.38) and Delta-X9-DR(0.41) were aged in an oven for 5 days at 50° C. in order to simulate longer-term storage, to assure that the initial color and the disappearing effect endured. The peroxide formulations after aging were designated Delta-X9-DR(0.35)-Aged, Delta-X9-DR(0.38)-Aged and Delta-X9-DR(0.41)-Aged.

The procedure of Examples 2-5 was used to evaluate the aged peroxide formulations in the curing application. The results are shown in Table 3.

TABLE 3
Change in Red Color (as a*) Before and After Cure using MEKP
Formulations Containing the Dye of Formula 1

| | Red Color (as a*) | | | |
|---|---|---|---|---|
| | | | | Example 9 |
| | Example 6 | Example 7 | Example 8 | Competitive |
| | Initiator: Delta- | Initiator: Delta- | Initiator: Delta- | Commercial |
| Time | X9-DR(0.35)- | X9-DR(0.38)- | X9-DR(0.41)- | Control |
| (min) | Aged | Aged | Aged | (also aged) |
| 2 | — | 7.40 | 7.67 | 5.06 |
| 3 | 6.65 | — | 6.95 | 4.83 |
| 4 | 5.90 | 5.91 | — | — |
| 5 | 4.82 | 4.77 | — | 3.60 |
| 6 | — | — | 3.65 | — |
| 10 | — | 1.25 | 1.07 | 1.34 |
| 12 | 0.66 | — | — | — |
| 15 | 0.38 | 0.35 | 0.20 | 0.70 |
| 20 | 0.12 | 0.22 | 0.77 | 0.43 |
| 25 | 0.00 | 0.00 | 0.65 | 0.34 |
| 30 | −0.06 | 0.11 | 0.51 | 0.42 |

The results showed the excellent storage stability of the MEKP formulations containing the dye of formula 1 since the initial red color of the system before cure was comparable to that of the un-aged formulations. The disappearance of the color with cure was also similar to that for un-aged formulations.

### Examples 10-20

### Gassing Testing of MEKP and MEKP/CHP Formulations Containing the Dye of Formula 1

Several MEKP and MEKP/CHP formulations containing the dye of formula 1 were exposed to 50° C. for 5 days and the extent of gas evolution was measure and compared to commercial formulations containing a permanent red dye. The occurrence of gassing is indicative of peroxide instability in MEKP formulations. The results are shown in Table 4.

TABLE 4

| | | Gas | |
|---|---|---|---|
| Example | Initiator | Rating | Result |
| 10 | Delta-X9-DR(0.35) | 0 | Passed |
| 11 | Delta-X9-DR(0.38) | 0 | Passed |
| 12 | Luperox Delta-X9 Red | 1.0 | Passed |
| | (permanent dye, Sample A) | | |
| 13 | Luperox Delta-X9 Red | 8.0 | Failed |
| | (permanent dye, Sample B) | | |
| 14 | DDM-30-DR | 0 | Passed |
| 15 | KC70-DR | 0 | Passed |
| 16 | DDM-9-DR(0.47) | 0 | Passed |
| 17 | DHD-9-DR | <1 | Passed |
| 18 | 224-DR | <1 | Passed |
| 19 | Cat730-DR | 0 | Passed |
| 20 | Cat11-DR | 0 | Passed |

An initiator with the lower gas rating means that it is more stable. An initiator with a gas rating of zero means it did not gas at all. The results show that MEKP formulations containing the dye of formula 1 are as safe as, or better than, the current commercial red products containing a permanent red dye. (The difference in gas rating between commercial controls A and B is due to the quality of the dye used. This suggests that using the inventive, disappearing dye might alleviate existing quality problems associated with use of the current permanent red dye. This is another important, unobvious feature of the inventive dye.)

In order to confirm formulation stability during exposure to cold temperatures (as occur during shipping in winter months) samples of Delta X-9-DR(0.35), Delta-X9-DR(0.38) and Delta X-9-DR(0.41) were exposed to −20° C. for 14 days. Visual observation of the samples after exposure indicated no undesirable precipitation of dye.

### Examples 21-23

### Use of MEKP Containing the Dye of Formula 1 to Cure Filled, Unsaturated Polyester Resin

Unsaturated polyester resin compositions were prepared by mixing 45 wt-% of unsaturated polyester resin (POLYLITE 33303-24), 55 wt-% of calcium carbonate and 1 phr of dyed organic peroxide initiators shown in Table 5. The mixtures cured at room temperature due to the presence of metal promoter formulated into the resin by the manufacturer, and the disappearance of the initiator red color was demonstrated by measuring the red color component (a*) as described above.

TABLE 5
Change in Red Color (as a*) Before and After Cure using MEKP
Formulations Containing the Dye of Formula 1

| | Red Color (as a*) | | |
|---|---|---|---|
| | Example 21 | Example 22 | Example 23 |
| | Initiator: DDM9- | Initiator: DHD9- | Initiator: DDM-30- |
| Time (min) | DR(0.47) | DR | DR |
| 2 | — | 9.32 | — |
| 3 | — | — | 9.23 |
| 4 | — | 9.65 | 9.12 |
| 5 | 9.37 | 10.03 | 9.21 |
| 10 | — | — | 10.09 |
| 12 | 9.70 | — | — |
| 17 | 8.68 | — | — |
| 20 | — | — | 9.55 |
| 22 | 4.76 | — | — |
| 25 | — | 2.33 | — |
| 27 | 2.57 | — | — |
| 30 | — | 1.08 | — |
| 31 | — | — | 3.18 |
| 32 | 0.92 | — | — |
| 34 | 0.56 | — | — |
| 35 | — | 0.40 | — |
| 37 | 0.27 | — | 1.27 |
| 40 | — | 0.12 | 0.75 |
| 42 | 0.08 | — | — |
| 45 | — | — | 0.45 |

### Examples 24-26

### Use of MEKP Containing (1) to Cure Unfilled, Unsaturated Polyester Resin

The 75° F. SPI gel-cure test of 2.0 phr of DDM-9-DR(0.47), or Luperox DDM-9 Red (permanent red dye, control) or Luperox DDM-9 (no dye) with unsaturated polyester resin (POLYLITE 33306-00) also indicated that DDM-9-DR(0.47) has similar curing speed as the commercial permanent red and un-dyed control. In addition, the Barcol hardness of each cured sample was measured. The results are listed in Table 6.

TABLE 6
Comparison Gel-Cure Data Using MEKP Formulation
Containing the Dye of Formula 1

| | | Gel | | Peak | |
|---|---|---|---|---|---|
| | | time | Cure time | Exotherm | Barcol |
| Example | Initiator | (min) | (min) | (° F.) | Hardness |
| 24 | DDM-9-DR(0.47) | 36.1 | 44.5 | 245 | 25-30 |
| 25 | Luperox DDM-9 | 35.9 | 44.8 | 245 | 20-25 |
| | Red | | | | |
| 26 | Luperox DDM-9 | 35.0 | 44.3 | 249 | 20-30 |

### Examples 27-34

### Effect on Assay of Adding the Dye of Formula 1 to Commercial MEKP Formulations

The starting materials and dyed products as described in Example 1 were tested for any effect on the active oxygen content due to the presence of the added (1). In this test the same peroxide sample was tested as both the dyed formulation and un-dyed control. The results are shown in Table 7.

TABLE 7
Active Oxygen Content of MEKP Formulations With and Without the
Dye of Formula 1

| | | (1) Content | Active Oxygen |
|---|---|---|---|
| Example | Initiator | (%) | Content (%) |
| 27 | Luperox DDM-9 | None | 8.91 |
| 28 | | 0.47 | 8.78 |
| 29 | Luperox DHD-9 | None | 8.89 |
| 30 | | 0.60 | 8.81 |
| 31 | Luperox Delta X-9 | None | 8.83 |
| 32 | | 0.60 | 8.79 |
| 33 | Luperox DDM-30 | None | 5.82 |
| 34 | | 0.60 | 5.76 |

The addition of the dye of formula 1 to the commercial MEKP formulations did not have a negative effect on the initial active oxygen content of the formulations. The results are further indication that these products are very stable.

### Examples 35-38

### Use of MEKP Containing the Dye of Formula 1 to Cure Filled, Unsaturated Polyester Resin

Unsaturated polyester resin compositions were prepared by mixing 45 wt-% of unsaturated polyester resin (POLYLITE 33303-24), 55 wt-% of calcium carbonate and 1% of dyed organic peroxide initiators shown in Table 8. The mixtures were cured at room temperature due to the presence of metal ion promoter in the commercial resin, and the disappearance of the initiator red color was demonstrated by measuring the red color component (a*) as described above.

TABLE 8
Change in Red Color (as a*) Before and After Cure using MEKP
Formulations Containing the Dye of Formula 1

| | Red Color (as a*) | | | |
|---|---|---|---|---|
| | Example 35 | Example 36 | | |
| | Initiator: | Initiator: | Example 37 | Example 38 |
| Time | DDM-9- | DDM-9- | Initiator: DDM-9- | Initiator: DDM-9- |
| (min) | DR(0.16) | DR(0.24) | DR(0.96) | DR(1.41) |
| 1 | 3.79 | 5.14 | 13.90 | 16.91 |
| 2 | 3.41 | 4.74 | 13.41 | 16.47 |
| 3 | 3.38 | 4.53 | 13.20 | 16.34 |
| 4 | 3.54 | 4.60 | 13.08 | 16.33 |
| 5 | 4.02 | 4.90 | 13.31 | 16.56 |
| 15 | 4.70 | 5.82 | 13.99 | 17.26 |
| 20 | 4.64 | 5.84 | 13.76 | 16.70 |
| 30 | 3.16 | 4.29 | 9.50 | 13.29 |
| 40 | 1.16 | 1.81 | 4.02 | 5.95 |
| 50 | 0.33 | 0.54 | 1.30 | 1.64 |
| 60 | — | — | 0.16 | 0.39 |
| 65 | — | — | 0.03 | 0.10 |

### Example 39

### Use of Cumene Hydroperoxide Containing (1) to Cure Filled, Unsaturated Vinyl Ester Resin System

A vinyl ester resin composition was prepared by mixing 45 g of vinyl ester resin (Derakane Momentum 411-350), 55 g of calcium carbonate, 0.2 g of cobalt naphthenate (6%), 0.1 g of N,N-dimethylaniline, and 1.5 phr of CU90-DR. The mixture cured at room temperature, and the disappearance of the initiator red color was demonstrated by measuring the red color component (a*) as described above. The results are shown in Table 9.

TABLE 9
Change in Red Color (as a*) Before and After
Cure using CU90-DR

| Time (min) | a* |
|---|---|
| 1 | 9.09 |
| 2 | 8.44 |
| 3 | 7.87 |
| 4 | 7.24 |
| 5 | 6.62 |
| 10 | 4.5 |
| 20 | 2.43 |
| 30 | 1.38 |
| 40 | 0.77 |
| 50 | 0.47 |
| 60 | 0.33 |
| 70 | 0.25 |
| 80 | 0.15 |

### Example 40

### Use of MEKP/CHP Blends Containing the Dye of Formula 1 to Cure Filled, Unsaturated Polyester Resin System

Unsaturated polyester resin composition was prepared by mixing 45 wt-% of unsaturated polyester resin (POLYLITE 33306-00), 55 wt-% of calcium carbonate and 1.5 phr of KC70-DR. The mixture was cured at room temperature due to the presence of metal ion promoter in the commercial resin, and the disappearance of the red color was demonstrated by measuring the red color component (a*) as described above. The results are shown in Table 10.

TABLE 10
Change in Red Color (as a*) Before and
After Cure using KC70-DR

| Time (min) | a* |
|---|---|
| 1 | 11.19 |
| 2 | 10.82 |
| 5 | 11.64 |
| 10 | 11.63 |
| 20 | 6.97 |
| 30 | 2.09 |
| 40 | 0.50 |
| 50 | 0.13 |

### Example 41

### Stability Testing of 2.4-Pentanedione Peroxide Formulation Containing the Dye of Formula 1

A 2,4-pentanedione peroxide formulation containing the dye of formula 1, 224-DR, was aged for 5 days at 50° C. to compare the stability and gassing to that of un-aged peroxide. The comparison is shown in Table 11.

TABLE 11
Stability Results for 224-DR

| | Average % Active | Gassing |
|---|---|---|
| Sample | Oxygen | Rating |
| 224-DR (Un-aged) | 4.020 | N/A |
| 224-DR-Aged | 3.942 | <1 |

N/A means not applicable

The results show the good stability of 2,4-pentanedione peroxide formulation containing the dye of formula 1.

### Example 42

### Use of 2,4-Pentanedione Peroxide Formulation Containing (1) to Cure Filled, Unsaturated Polyester Ester Resin System

Unsaturated polyester resin composition was prepared by mixing 45 wt-% of unsaturated polyester resin (POLYLITE 33306-00), 55 wt-% of calcium carbonate and 1.5 phr of 224-DR. Cure was effected at room temperature, and the disappearance of the initiator red color was demonstrated by measuring the red color component (a*) described above. The color variation with time is shown in Table 12.

TABLE 12
Change in Red Color (as a*) Before and
After Cure using 224-DR

| Time (min) | a* |
|---|---|
| 1 | 12.02 |
| 2 | 11.54 |
| 3 | 11.33 |
| 4 | 11.18 |
| 5 | 11.08 |
| 10 | 11.55 |
| 15 | 11.28 |
| 20 | 6.00 |
| 25 | 1.00 |
| 30 | −0.93 |

### Example 43

### Use of Two Peroxide Initiators Containing the Dye of Formula 1 to Cure Filled, Unsaturated Polyester Ester Resin System

Unsaturated polyester resin composition was prepared by mixing 100 g of unsaturated polyester resin (Pultru P920-300), 40 g of calcium carbonate, 1.5 phr of ATC50-DR, and 0.2 phr of P-DR. The resin mixture was stable at room temperature. The a* (red color component) of this resin mixture before and after cure was measured as described above. Before thermal cure, the a* value was 13.53 at room temperature after the peroxides were mixed in the resin 10 min. After cure at 180° F. for 65 min, the a* value was −1.47. The red color completely disappeared and the resin hardened. This shows the use of both dyed diacyl peroxide pastes, and dyed peroxyesters to successfully effect cure.

### Examples 44-50

### Use of Various Initiators Containing the Dye of Formula 1 to Cure Filled, Unsaturated Polyester Ester Resin System

Unsaturated polyester resin compositions were prepared by mixing 52 g of unsaturated polyester resin (S903), 32 g of poly(vinyl acetate) (Low Profile Additive LP-4016), 16 g of 40% poly(methyl methacrylate) (Acrylic Polymer 7301-IAXP) dissolved in styrene, 3 g of zinc stearate, 80 g of calcium carbonate and 2.30 g of various dyed organic peroxide initiators shown in Table 13. The mixtures cured at elevated temperature, and the disappearance of the initiator red color was demonstrated by measuring the red color component (a*) as described above. The color variation with temperature and time is shown in Table 13.

TABLE 13
Change in Red Color (as a*) Before and After Cure using Various Dyed Organic Peroxides

| | | Example | | | | | | |
|---|---|---|---|---|---|---|---|---|
| | | 44 | 45 | 46 | 47 | 48 | 49 | 50 |
| Initiator | P-DR | 2.30 g | — | — | — | — | — | — |
| | TAP-DR | — | 2.30 g | — | — | — | — | — |
| | TBEC-DR | — | — | 2.30 g | — | — | — | — |
| | TBIC-M75- | — | — | — | 2.30 g | — | — | — |
| | DR | | | | | | | |
| | MC-DR | — | — | — | — | 2.30 g | — | — |
| | 7M75-DR | — | — | — | — | — | 2.30 g | — |
| | 555M60- | — | — | — | — | — | — | 2.30 g |
| | DR | | | | | | | |

| | | | | | | | |
|---|---|---|---|---|---|---|---|
| a*, 10 min after | 10.96 | 10.92 | 11.52 | 10.75 | 11.09 | 10.82 | 11.18 |
| mixing at RT | | | | | | | |
| a*, after cure at | −0.96 | −0.81 | −0.88 | −0.96 | −0.73 | −0.82 | −0.72 |
| 300° F. for 20 min | | | | | | | |
| then cooling to | | | | | | | |
| ambient temperature | | | | | | | |

The data shows the general utility of organic peroxides, particularly peroxyesters and monoperoxycarbonates containing the dye of formula 1 for curing unsaturated polyester resin systems. The red color of the reaction mixture was readily apparent at room temperature after the peroxide was mixed into the resin. The red color virtually disappeared (a*<0) after thermal cure.

### Example 51

### Use of Diperoxyketals Containing the Dye of Formula 1 to Cure Filled, Unsaturated Polyester Ester Resin System

Unsaturated polyester resin compositions were prepared by mixing 52 g of unsaturated polyester resin (S903), 32 g of poly(vinyl acetate) (Low Profile Additive LP-4016), 16 g of 40% poly(methyl methacrylate) (Acrylic Polymer 7301-IAXP) dissolved in styrene, 3 g of zinc stearate, 80 g of calcium carbonate and 2.30 g of dyed organic peroxide initiators (either 231N70-DR or 231T70-DR). After 10 min of mixing the dyed peroxide formulations with the resin system, the dark red mixtures had a* values of 11.10 when 231T70-DR was used and 12.24 when 231N70-DR was used. After curing at 300° F. for 20 min, a* values were −0.70 and −0.59 respectively for the cured resin systems, indicating virtually complete disappearance of the red color.

### Examples 52-55

### Use of Various Initiators Containing the Dye of Formula 1 to Cure Filled, Unsaturated Polyester Ester Resin System

Unsaturated polyester resin compositions were prepared by mixing 52 g of unsaturated polyester resin (S903), 32 g of poly(vinyl acetate) (Low Profile Additive LP-4016), 16 g of 40% poly(methyl methacrylate) (Acrylic Polymer 7301-IAXP) dissolved in styrene, 3 g of zinc stearate, 80 g of calcium carbonate, and 2.30 g of various dyed organic peroxide initiator as shown in Table 14. The mixtures were cured at 300° F. elevated temperature, and the disappearance of the initiator red color was demonstrated by measuring the red color component (a*) as described earlier. The color variation with temperature and time is shown in Table 14.

TABLE 14
Change in Red Color (as a*) Before and
After Cure using Various Dyed Organic Peroxides

| | | Example | | | |
|---|---|---|---|---|---|
| | | 52 | 53 | 54 | 55 |
| Initiator | 26-DR | 2.30 g | — | — | — |
| | 575-DR | — | 2.30 g | — | — |
| | 256-DR | — | — | 2.30 g | — |
| | M33-DR | — | — | — | 2.30 g |

| | | | | |
|---|---|---|---|---|
| a*, 10 min after | 10.61 | 10.59 | 10.83 | 9.64 |
| mixing at RT | | | | |
| a*, after being in 300° F. | −0.18 | −0.49 | −0.54 | −0.62 |
| oven for 20 min then | | | | |
| cooling to ambient | | | | |
| temperature | | | | |

These examples demonstrate the effect use of dyed peroxyesters and mixtures of peroxyesters and diperoxyketals for conducting free radical reactions.

### Example 56-57

### Use of Various Initiators Containing the Dye of Formula 1 to Cure Filled, Unsaturated Polyester Ester Resin System

Unsaturated polyester resin compositions were prepared by mixing 100 g of unsaturated polyester resin (Pultru P920-300 resin), 40 g of calcium carbonate, and the specified dyed organic peroxide initiators shown in Table 15. The mixtures were cured at elevated temperature, and the disappearance of the initiator red color was demonstrated by measuring the red color component (a*) as described above. The color variation with temperature and time is shown in Table 15.

TABLE 15
Change in Red Color (as a*) Before and After Cure using
Various Dyed Organic Peroxides

Example

| | 56 | 57 |
|---|---|---|
| 223V75-DR | 1.00 g | 0.75 g |
| 575-DR | — | 0.30 g |
| P-DR | — | 0.20 g |
| a*, 10 min after mixing at RT | 7.53 | 9.70 |
| a*, after being in 180° F. oven for | −1.59 | −1.72 |
| 20 min then cooling to ambient | | |
| temperature | | |

These examples demonstrate the effect use of dyed peroxydicarbonates and dyed peroxyesters for conducting free radical reactions.

### Example 58

### Use of a Peroxydicarbonate and Peroxyester Containing (the Dye of Formula 1 to Cure Filled, Unsaturated Polyester Ester Resin System

Unsaturated polyester resin composition was prepared by mixing 98.5 g of unsaturated polyester resin (Aropol MR 12018), 1.0 g of 223V75-DR and 0.5 g P-DR. The mixture cured at elevated temperature, and the disappearance of the initiator red color was demonstrated by measuring the red color component (a*) as described above. The a* value of the reaction mixture was 11.01 at room temperature after the dyed organic peroxides were added to the resin. After cure, at 140° C. for 35 min, the a* value dropped to 0.91. The resin had cured and the red color had disappeared.

This example shows the effective use of dyed peroxydicarbonate formulations and dyed peroxyester formulations used in free radical reactions.

### Example 59

### The Preparation of Polystyrene from t-Butyl Peroxybenzoate and Styrene

Styrene with 0.1% of P-DR was polymerized under nitrogen atmosphere in two stages, the first was 130° C. for 2.5 hrs and the second was 180° C. for 2.5 hrs. The a* value (red color component) of the monomer and dyed peroxide mixture was greater than 4.4 at room temperature. The a* dropped to less than 0.17 after the two thermal polymerization stages. Virtually all of the red color disappeared during the styrene polymerization. The final molecular weight of the polystyrene produced by the above reaction was determined to be 288,000 g/mole that is comparable to the molecular weight of the polystyrene produced with Luperox P at the same condition (typically 290,000 g/mole).

### Example 60

### The Crosslinking of Silicone Rubber with 101N78S-DR

A mixture having 1% concentration of 101N78S-DR was prepared by mixing the peroxide with silicone rubber (GE Silicones TR55) in a Brabender mixer until the sample had a uniform red color, indicating that the peroxide was homogenously distributed throughout the rubber. A portion of this mixture was placed in a Monsanto Oscillating Disk Rheometer (MODR) at 180° C. for 3 sec to press the sample and get a starting color value, for 0.25 min to get an intermediate color value for partial crosslinking and for 20 minutes to effect complete cure. The disappearance of the initiator red color was demonstrated by measuring the red color component (a*) as described above. The color variation with temperature and time is shown in Table 16.

TABLE 16
Change in Red Color (as a*) Before and After Silicone
Rubber Cure using 101N78S-DR

| Cure time and temperature | a* |
|---|---|
| 3 sec at 28° C. | 8.06 |
| 0.25 min at 180° C. | 4.18 |
| 20 min at 180° C. | 0.20 |

The data demonstrate the utility of the dyed dialkyl peroxide formulations for crosslinking rubber.

While the present invention has been described with respect to particular embodiments thereof, it is apparent that numerous other forms and modifications of this invention will be obvious to those skilled in the art. The appended claims and this invention generally should be construed to cover all such obvious forms and modifications which are within the true spirit and scope of the present invention.

We claim:

1. A pigmented organic peroxide composition comprising an organic peroxide and a dye of the formula:

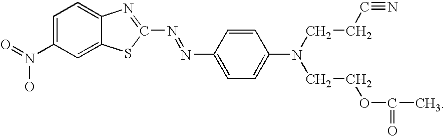

2. The pigmented organic peroxide composition of claim 1 wherein said organic peroxide is selected from the group consisting of ketone peroxides, diacyl peroxides, dialkyl peroxides, diperoxyketals, peroxydicarbonates, peroxyesters, hydroperoxides and mixtures thereof.

3. The pigmented organic peroxide composition of claim 2 wherein said organic peroxide is selected from the group consisting of methyl ethyl ketone peroxide, cumene hydroperoxide, 2,4-pentanedione peroxide, benzoyl peroxide, t-butyl peroxybenzoate, t-amyl peroxybenzoate, OO-(t-butyl) O-(2-ethylhexyl) monoperoxycarbonate, OO-(t-butyl) O-isopropyl monoperoxycarbonate, OO-(t-amyl) O-(2-ethylhexyl) monoperoxycarbonate, t-butyl peroxyacetate, t-amyl peroxyacetate, 1,1-di(t-butylperoxy)cyclohexane, 1,1-di(t-amylperoxy)cyclohexane, 1,1-di(t-butylperoxy)-3,3,5-trimethylcyclohexane, t-butyl peroxy-2-ethylhexanoate, t-amyl peroxy-2-ethylhexanoate, 2,5-di(2-ethylhexanoylperoxy)-2,5-dimethylhexane, di(2-ethylhexyl) peroxydicarbonate, and 2,5-di(t-butylperoxy)-2,5-dimethylhexane.

4. The pigmented organic peroxide composition of claim 1 further comprising a component selected from the group consisting of unsaturated polyester resin, vinyl ester resin, vinyl monomer, curable rubber, curable elastomer.

5. A process for curing unsaturated polyester resin or vinyl ester resin wherein the pigmented organic peroxide composition of claim 1 is added to an unsaturated polyester resin or vinyl ester resin.

6. A process for polymerizing vinyl monomers wherein the pigmented organic peroxide composition of claim 1 is added to vinyl monomers.

7. A process for curing elastomers wherein the pigmented organic peroxide composition of claim 1 is added to elastomers.

8. A process for crosslinking polymers wherein the pigmented organic peroxide composition of claim 1 is added to polymers.
